(19) United States
(12) Patent Application Publication
(10) Pub. No.: US 2026/0060260 A1
(43) Pub. Date: Mar. 5, 2026

(54) SMOKING COOKING STATION WITH HEAT BAFFLE AND METHOD THEREOF

(71) Applicant: North Atlantic Imports, LLC, Logan, UT (US)

(72) Inventor: Jared M. Smith, Paradise, UT (US)

(21) Appl. No.: 19/315,559

(22) Filed: Aug. 31, 2025

Related U.S. Application Data
(60) Provisional application No. 63/689,714, filed on Sep. 1, 2024.

(51) Int. Cl. A23B 4/052; F24B 13/04; F24C 15/14

(52) U.S. Cl. CPC A23B 4/0523; F24B 13/04; F24C 15/14

(57) ABSTRACT

A smoker cooking station configured to disperse heat and smoke evenly with a heat baffle. The smoker cooking station including a main body and a pellet feeder system, the pellet feeder system configured to feed pellets to a fire pot. The heat baffle may be positioned in the main body and over the fire pot such that the heat baffle includes a dome structure configured to hold heated smoke along an underside of the dome structure. The heat baffle includes multiple openings defined therein configured to disperse the heated smoke along a length of the heat baffle via the openings to, thereby, disperse the heated smoke within a cooking chamber in a more consistent and even manner.

### CROSS-REFERENCE TO RELATED APPLICATIONS

This application claims the benefit of U.S. Provisional Application No. 63/689,714, filed Sep. 1, 2024, the disclosure of which is hereby incorporated by reference herein in its entirety.

### TECHNICAL FIELD

The present invention relates generally to outdoor type cooking stations and, more specifically, the present invention relates to evenly diffusing or dispersing heat within cooking stations.

### BACKGROUND

Outdoor cooking has become a popular and pervasive tradition in much of the world. There are several varieties of outdoor cooking stations such as gas fueled, electric, or charcoal. Gas fueled cooking stations typically use propane or natural gas to provide a gas flame which in turn can either cook the food directly or heat an element which radiates heat to cook the food. Electric cooking stations typically warm a heating element which radiates heat to cook the food. Lastly, a charcoal cooking station will radiate heat generated by charcoal and cook the food. Each different variety of outdoor cooking stations can impart unique flavors.

Another mode of outdoor cooking which imparts unique flavors is a smoker device. Some smoker devices use pellets as a fuel source which are typically ignited with an electric heating element within a cup like container known as a fire pot typically located below or at a level below the cooking chamber. The burning pellets produce heated smoke which in turn will cook the food and impart a smokey flavor to the food. The heated smoke typically travels from the fire pot to the cooking chamber from a lower portion to an upper portion of the cooking chamber. One of the challenges with heating the cooking chamber with smoke is evenly dispersing the smoke within the cooking chamber to ensure the smokey flavor is imparted to all the food being cooked.

### BRIEF SUMMARY OF THE INVENTION

The present invention is directed to various embodiments of a smoker cooking station configured to be fueled with pellets and configured to disperse heat and smoke in a substantially even manner. In one embodiment, the smoker cooking station includes a main body with a heat baffle. The main body extends to define a pellet feeder system and a smoking chamber. The pellet feeder system extends to a fire pot positioned adjacent a lower floor of the main body. The pellet feeder system is configured to feed the pellets to the fire pot to be ignited and to produce heated smoke therein. The heat baffle includes a tent structure with multiple openings defined therein, the multiple openings each having a leading edge along one side of the multiple openings. The leading edge of each of the multiple openings are aligned with each other along a majority of a length of the tent structure. The heat baffle is positioned above the fire pot so that the tent structure is fillable with heated smoke from the fire pot. Upon an upper portion of the tent structure being filled with the heated smoke, the heated smoke escapes the tent structure along the leading edge of each of the multiple openings aligned along the length of the heat baffle so that the heated smoke rises from each of the multiple openings along the majority of the length of the heat baffle to assist in evenly dispersing the heated smoke throughout the smoking chamber of the main body.

In another embodiment, the tent structure extends to define an underside, the tent structure extending to a front periphery and a rear periphery such that the multiple openings include front periphery openings and rear periphery openings, the front periphery openings aligned adjacently along the front periphery of the tent structure and the rear periphery openings aligned adjacently along the rear periphery of the tent structure. In a further embodiment, the front periphery openings of the multiple openings are substantially evenly spaced apart and aligned relative to each other, and the rear periphery openings of the multiple openings are substantially evenly spaced apart and aligned relative to each other. In another embodiment, the front periphery openings each define a front side leading edge, the front side leading edge of each of the front periphery openings are aligned with each other, and wherein the rear periphery openings each define a rear side leading edge, the rear side leading edge of each of the rear periphery openings are aligned with each other. In still another embodiment, the front side leading edge of the front periphery openings are at a substantially common height in the tent structure as the rear side leading edge of the rear periphery openings such that, upon the heated smoke filling the upper portion of the tent structure, the heated smoke escapes the tent structure along the front side leading edge and the rear side leading edge of the respective front and rear periphery openings in an even and consistent manner.

In another embodiment, the tent structure extends with an upper panel having a peak along a length of the upper panel, the upper panel having a first upper side and a second upper side each sloped downward from the peak toward a front periphery and a rear periphery, respectively, the tent structure having a left wall and a right wall positioned adjacent respective opposite ends of the peak so that the left wall and the right wall each extend between the front periphery and the rear periphery along opposite sides of the tent structure. In another embodiment, the main body includes a drip pan and at least one cooking grate, the drip pan positioned above the heat baffle, and the at least one cooking grate positioned above the drip pan. In still another embodiment, the heat baffle is positioned below the drip pan such that heated smoke rises around a periphery of the drip pan. In yet another embodiment, the drip pan is separate from the heat baffle such that, the drip pan is removable from the main body independent of the heat baffle.

In another embodiment, the tent structure of the heat baffle extends with a peak portion, the peak portion extending between a left wall and a right wall of the tent structure, the tent structure include a front sloped panel and a rear sloped panel each extending from the peak portion to a front periphery and a rear periphery, respectively, of the tent structure. In another embodiment, the multiple openings are evenly spaced apart and aligned with each other. In still another embodiment, the heat baffle is positioned and oriented within the main body so that the multiple openings disperse heated smoke in a substantially even manner within the smoking chamber. In another embodiment, the multiple openings are positioned on a periphery of the tent structure. In another embodiment, the tent structure extends with a sloped structure to hold heated smoke above the multiple openings defined in the heat baffle.

In accordance with another embodiment of the present invention, a smoker cooking station configured to be fueled by pellets and to disperse smoked heat therein in a substantially even manner is provided. The smoker cooking station includes a main body with a heat baffle. The main body extends to define a pellet feeder system and a smoking chamber, the pellet feeder system extending to a fire pot positioned adjacent a lower floor of the main body. The pellet feeder system is configured to feed the pellets to the fire pot to be ignited and to produce the heated smoke therein. The heat baffle extends to a periphery with multiple openings defined in the heat baffle, the multiple openings spaced apart and each defining a leading side edge such that the leading side edge of each of the multiple openings are aligned with each other. The heat baffle extends to define an underside configured to be above the multiple openings and configured to hold heated smoke therein. The heat baffle is configured to be positioned over the fire pot so that, upon heated smoke filling up a space along the underside of the heat baffle, the heated smoke escapes the underside of the heat baffle along the leading side edge of each of the multiple openings so that the heated smoke rises from each of the multiple openings along to assist in evenly dispersing the heated smoke throughout the smoking chamber of the main body.

In another embodiment, the main body includes a drip pan and at least one cooking grate, the drip pan positioned above the heat baffle, and the at least one cooking grate positioned above the drip pan. In another embodiment, the heat baffle is positioned below the drip pan such that heated smoke rises around a periphery of the drip pan. In a further embodiment, the drip pan is separate from the heat baffle such that, the drip pan is removable from the main body independent of the heat baffle.

In another embodiment, the heat baffle extends with a dome structure, the dome structure extending to a peak portion, the peak portion extending between a left wall and a right wall of the dome structure, the dome structure include a front sloped panel and a rear sloped panel each extending from the peak portion to a front periphery and a rear periphery, respectively, of the dome structure. In another embodiment, the multiple openings are evenly spaced apart and aligned with each other. In another embodiment, the heat baffle is positioned and oriented within the main body so that the multiple openings disperse heated smoke in a substantially even manner within the smoking chamber. In another embodiment, the multiple openings are positioned along a periphery of a dome structure. In still another embodiment, the dome structure extends with a sloped structure to hold heated smoke thereunder and above the multiple openings defined in the heat baffle.

In accordance with another embodiment of the present invention, a method for evenly dispersing heated smoke within a smoker cooking station is provided. The method includes the steps of: providing a main body and a pellet feeder system of the smoker cooking station, the pellet feeder system extending to a fire pot positioned adjacent a lower floor of the main body, the pellet feeder system configured to feed the pellets to the fire pot to be ignited and to produce heated smoke therein, the main body including a heat baffle having a tent structure with multiple openings defined therein, the multiple openings each having a leading edge along one side of the multiple openings, the leading edge of each of the multiple openings being aligned with each other along a majority of a length of the heat baffle, the heat baffle positioned above the fire pot within a smoking chamber of the main body; generating the heated smoke in the fire pot with pellets in the fire pot being fed thereto by the pellet feeder system such that the heated smoke rises to fill an upper portion along an underside of the tent structure; and dispersing the heated smoke evenly into the smoking chamber with the heated smoke moving from the underside of the heat baffle and out of the multiple openings along the leading edge of each of the multiple openings aligned along the length of the heat baffle so that the heated smoke rises from each of the multiple openings along the majority of the length of the heat baffle to assist in evenly dispersing the heated smoke throughout the smoking chamber of the main body.

In another embodiment, the step of providing the main body includes providing the main body including a drip pan and at least one cooking grate, the drip pan positioned above the heat baffle, and the at least one cooking grate positioned above the drip pan. In another embodiment, the dispersing step includes dispersing the heated smoke evenly from the heat baffle to flow and rise around a periphery of the drip pan. In another embodiment, the dispersing step includes dispersing heated smoke from the multiple openings that are evenly spaced apart and aligned with each other. In still another embodiment, the dispersing step includes orienting the heat baffle within the main body so that the multiple openings defined in the heat baffle disperses the heated smoke from each of the multiple openings in a substantially even manner within the smoking chamber. In another embodiment, the dispersing step includes dispersing the heated smoke from multiple openings being positioned on a periphery of the tent structure. In another embodiment, the dispersing step includes dispersing the heated smoke from the tent structure extending with a sloped structure to hold the heated smoke above the multiple openings defined in the heat baffle.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a smoker cooking station, depicting a smoker chamber with a lid in an open position, according to an embodiment of the present invention;

FIG. 2 is a front view of the smoker cooking station of FIG. 1, according to an embodiment of the present invention;

FIG. 3 is a partially exploded view of the smoker cooking station of FIG. 1, depicting the lid in the open position and a heat baffle, a grease pan, and a lower grate exploded from an interior lower portion of the smoker cooking station, according to another embodiment of the present invention;

FIG. 4 is a cross-sectional view of the smoker cooking station taken along section line 4-4 of FIG. 1, according to another embodiment of the present invention;

FIG. 4A is an enlarged view of a fire pot and the heat baffle taken from region 4A of FIG. 4, depicting pellets being funneled and ignited in the fire pot and smoke filling a space defined by the heat diffuser, according to another embodiment of the present invention;

FIG. 5 is a perspective cross-sectional view of the smoker cooking station taken along section line 5-5 of FIG. 1, according to another embodiment of the present invention;

FIG. 6 is an upper perspective view of the smoker cooking station, depicting the grease pan and the lower grate removed from an interior of the smoker cooking chamber, according to another embodiment of the present invention;

FIG. 7 is a cross-sectional view of the smoker cooking station taken along section line 7-7 of FIG. 1, according to another embodiment of the present invention;

FIG. 8 is a perspective view of the heat baffle, according to another embodiment of the present invention;

FIG. 9 is a bottom view of the heat baffle, according to another embodiment of the present invention;

FIG. 10 is a top view of the heat baffle, according to another embodiment of the present invention;

FIG. 11 is a side view of the heat baffle according to another embodiment of the present invention; and

FIG. 12 is a rear view of the heat baffle, according to another embodiment of the present invention.

### DETAILED DESCRIPTION OF THE INVENTION

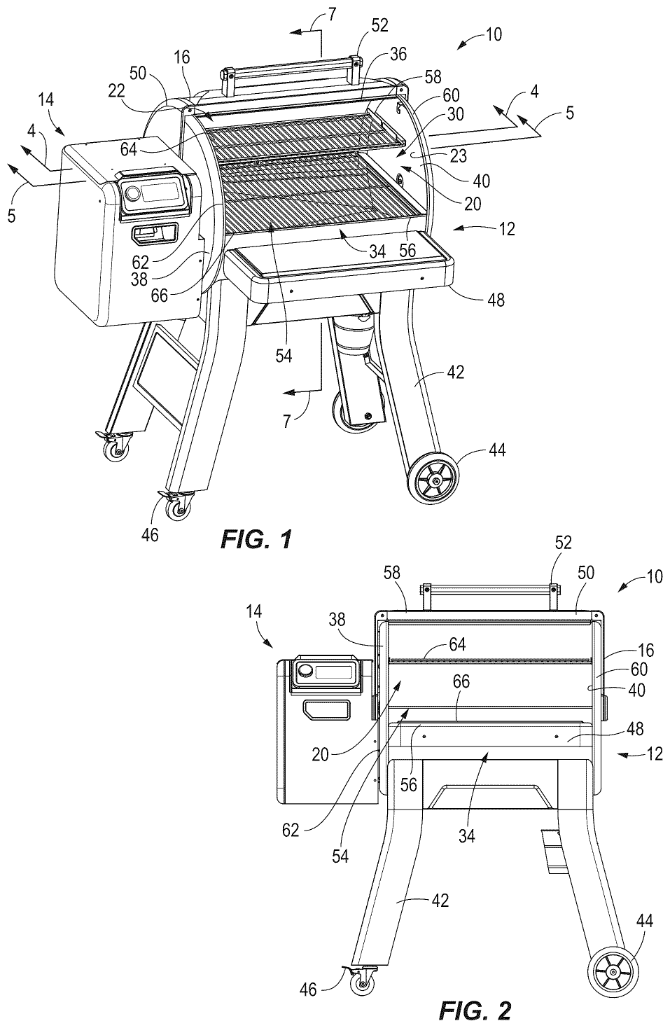

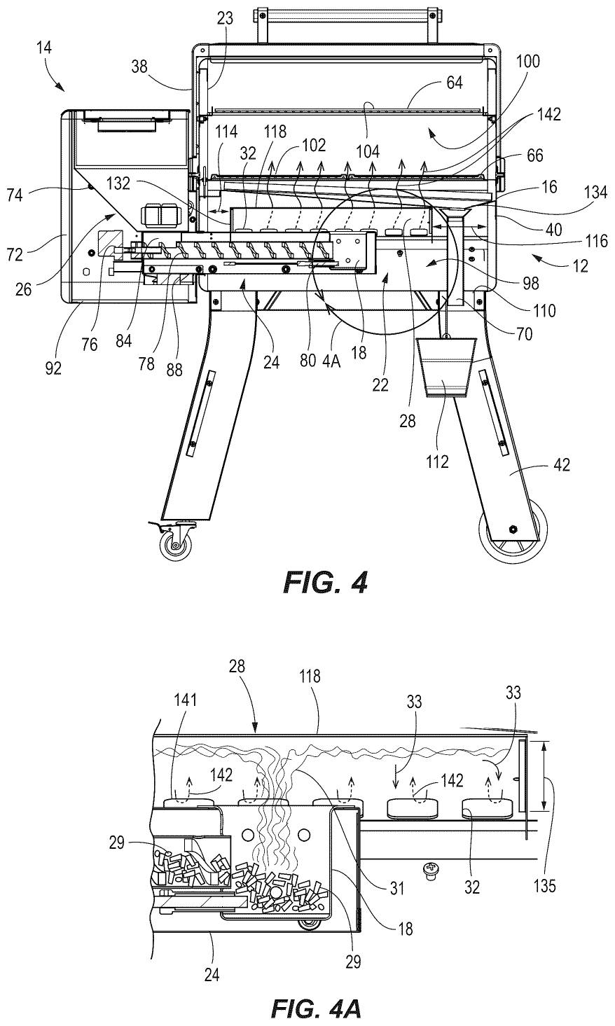

Referring to FIGS. 1, 3 and 4A, a cooking station 10 including a main body 12 is provided. The main body 12 may include a pellet feeder system 14 and a cooking body 16. The pellet feeder system 14 may be configured to facilitate movement of pellets to a fire pot 18 within the cooking body 16. The cooking body 16 may define an interior 20, the interior 20 at least partially being a smoking chamber 22. The fire pot 18 may be coupled to an auger housing 24 that may extend laterally from an opening of a pellet side portion 26 of the pellet feeder system 14. As such, the auger housing 24 may extend laterally into the smoking chamber 22 so that the fire pot 18 may be positioned within or below the smoking chamber 22. The fire pot 18 may be configured to burn pellets 29, providing heated smoke 31 into the smoking chamber 22. The smoking chamber 22 may include a heat baffle 28 with multiple spaced apart and aligned openings 32 defined therein, the heat baffle 28 positioned above the fire pot 18. The heat baffle 28 may be sized and configured to act as a tent structure 118 to hold or contain heated smoke 31 thereunder. As the tent structure 118 (or dome structure) of the heat baffle 28 fills with the heated smoke 31 (as depicted by arrow 33), the heated smoke 31 may be released or spills through the multiple openings 32 and into an upper chamber 100 or cooking chamber 23 above the heat baffle 28 (as depicted with arrows 142 in FIGS. 4, 6 and 8). Such openings 32 may be spaced and aligned so that the smoke rises into the cooking chamber 23 in a manner that allows for the heated smoke to flow in a more consistent flow throughout the cooking chamber 23.

With reference to FIGS. 1 and 2, as previously set forth, the cooking station 10 may include the main body 12. The main body 12 may include the pellet feeder system 14 and the cooking body 16. The cooking body 16 may extend to define a front side 3, a rear side 36, a left side 38, and a right side 40. The front side 34 may extend opposite of the rear side 36. Similarly, the left side 38 may extend opposite of the right side 40. The pellet feeder system 14 may be coupled along the left side 38 of the cooking body 16. The main body 12 may also include legs 42 extending downward from the cooking body 16. The legs 42 may be coupled to the cooking body 16 and extend to wheels 44 coupled thereto. The wheels 44 may be configured to allow or facilitate for the cooking station 10 to be portable. Further, the wheels 44 may include brakes 46 coupled thereto and may be configured to lock the wheels 44 to minimize movement of the cooking station 10, as desired. The front side 34 of the cooking body 16 may include a front shelf 48 coupled thereto.

Now with reference to FIGS. 1, 2 and 7, in one embodiment, the cooking body 16 may extend with a generally cylindrical shape. The front side 34 and the rear side 36 of the cooking body 16 may extend with one panel to define the cylindrical shape. The left side 38 and the right side 40 may be positioned and coupled on either side of the front side 34 and the rear side 36 to close the cylindrical shape of the cooking body 16 off. In further embodiments, the cooking body 16 may extend in other forms, such as, for example, a rectangular or square cross-sectional shape to provide a cubical or cuboid shaped cooking body 16. The cooking body 16 may include a lid 50 moveably coupled thereto. The lid 50 may be coupled to the left side 38 and the right side 40 of the cooking body 16 and pivot therearound so as to rotate over the cylindrical cooking body 16. The lid 50 may include a handle 52 positioned thereon, the handle 52 configured to be utilized to lift and lower the lid 50 to move the lid 50 between respective open and closed positions. The handle 52 may extend along the length of the front side 34, such that, the handle 52 may extend between the left side 38 and the right side 40 of the cooking body 16. Upon the lid 50 being in the closed position, the lid 50 may be positioned at the front side 34 of the cooking body 16 with the handle 52 positioned at a mid-level and the front side 34 of the cooking body 16 that may facilitate a user to readily grab and move the lid 50. Upon the lid 50 being in the open position, the lid 50 may be rotated and positioned along the rear side 36 of the cooking body 16. Further, with the lid 50 in the open position, the handle 52 may be positioned along a top side of the cylindrical shaped cooking body 16 at a relatively low-profile level to grab the handle 52, the handle 52 sitting in an upright orientation. Even further, upon the lid 50 moving between the closed and open positions, the lid 50 may be moved between the respective front side 34 and rear side 36 of the cooking body 16. As such, the lid 50 may include or encompass a substantial portion of the front side 34 of the cooking body 16 when in the closed position and may be configured to slide over a substantial portion of the rear side 36 of the cooking body 16. As such, the lid 50 may rotatably extend over and may be slightly elevated relative to a stationary portion of the cooking body 16. Further, upon the lid 50 being in the open position, the cooking body 16 may define a chamber opening 54. The chamber opening 54 may be sized and configured to allow for access to the interior 20 of the cooking body 16, such as the cooking chamber 23 or the smoking chamber 22. The chamber opening 54 may be defined by a lower lip 56, an upper lip 58, a right lip 60, and a left lip 62. The upper lip 58 may be a lower end of the lid 50 when the lid 50 is in the open position. As such, upon the lid 50 being in the closed position, the upper lip 58 may rest upon, or extend adjacent to, the lower lip 56 so as to enclose the cooking chamber 23 and the smoking chamber 22. Additional detail and features of a smoker type cooking station with a similar cooking body 16 and lid 50 is disclosed in a commonly assigned U.S. Pat. No. 11,985,985, issued on May 21, 2024, the disclosure of which is incorporated herein in its entirety.

Now with reference to FIGS. 1-3, the smoking chamber 22 may be defined by the interior 20 of the cooking body 16. As previously stated, the cooking body 16 may extend in a generally cylindrical shape and define the front side 34, the rear side 36, the left side 38, and the right side 40 of the cooking body 16. As such, the smoking chamber 22 may be defined by the interior surface of the walls of the cooking body 16. The smoking chamber 22 may include an upper grate 64 and a lower grate 66 positioned therein. The upper grate 64 may extend above and parallel to the lower grate 66. The lower grate 66 may be positioned adjacent to the lower lip 56 of the chamber opening 54. In this manner, the lower grate 66 may extend from the rear side 36 to the lower lip 56 of the cooking body 16, or the front side 34 of the cooking body 16. The upper grate 64 may extend from the rear side 36 towards the front side 34 of the cooking body 16, but may be smaller than the lower grate 66 due to the minimized space along an upper portion of the smoking chamber 22. The upper grate 64 and the lower grate 66 may be sized and configured to receive food product thereon and to cook such food product within the smoking chamber 22. In another embodiment, the space within the smoking chamber 22 that holds the upper and lower grates 64, 66 may be a cooking chamber 23, the cooking chamber defined by the interior surfaces of the cooking body 16 and an upper surface of a grease pan 68.

The smoking chamber 22 may also include the heat baffle 28 and the grease pan 68. The heat baffle 28 and the grease pan 68 may be positioned below the lower grate 66, and the grease pan 68 may be positioned above the heat baffle 28. Further, the heat baffle 28 and the grease pan 68 may be positioned above the auger housing 24 of the pellet feeder system 14 and a grease conduit 70. The heat baffle 28 may be positioned below the grease pan 68 such that the grease pan 68 may be positioned directly below the lower grate 66. In some embodiments, the heat baffle 28 may be smaller than the grease pan 68 such that the grease conduit 70 may be positioned to one side of the heat baffle 28. Further, the heat baffle 28 may be sized and configured to direct heated smoke 31 (FIG. 4A) generated within the fire pot 18 in a somewhat controlled and even dispersing manner within the smoking chamber 22. The grease pan 68 may be positioned directly above the heat baffle 28 and below the lower grate 66. Further, the grease pan 68 may be sized and configured to capture grease drippings and food debris, from the upper grate 64 and the lower grate 66, and direct the grease drippings and food debris to the grease conduit 70.

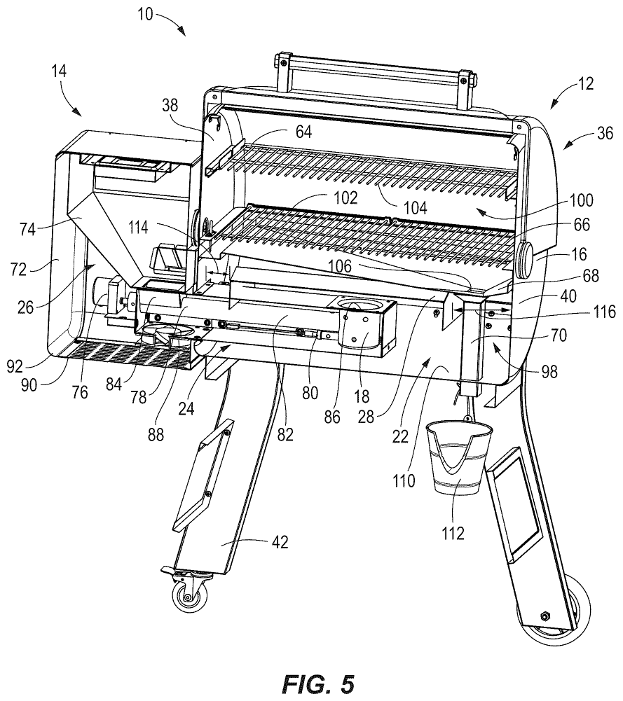

With reference to FIGS. 4 and 5, the pellet feeder system 14 may be coupled to the cooking body 16. The pellet feeder system 14 may be sized and configured to feed pellets 29 (FIG. 4A) to the fire pot 18 positioned within the smoking chamber 22. Further, the pellet feeder system 14 may include a housing 72, a pellet hopper 74, a motor 76, an auger 78, a heating element 80, and the fire pot 18. The housing 72 of the pellet feeder system 14 may include the pellet side portion 26 and the auger housing 24. The pellet side portion 26 may include the pellet hopper 74, the motor 76, and a portion of the auger 78 and the auger housing 24 to house the remaining portion of the auger 78. Further, the pellet feeder system 14 may include the heating element 80, and the fire pot 18. The heating element 80 may be an electrical heating element that may be sized and configured to extend into the fire pot 18 to ignite the pellets 29 (FIG. 4A). Such heating element 80 may be the type that is commonly known as a “hot rod.” The pellet hopper 74 may extend within the housing 72 with an opening 84 defined at a lower side of the pellet hopper 74 to feed pellets to the auger 78. Such pellet hopper 74 may be sized and configured to funnel pellets to the auger 78. As such, the pellet hopper 74 may extend in a somewhat funneled shape toward the auger 78 such that the pellet hopper 74 may funnel the pellets into the auger housing 24 and to the auger 78. The motor 76 may be positioned within the housing 72 below the pellet hopper 74 and coupled below the pellet hopper 74. Further, the motor 76 may be sized and configured to rotate the auger 78 to move the pellets 29 along the auger 78. Such auger 78 may also be positioned within a tubular casing 82 sized to hold the auger 78. With this arrangement, the pellet hopper 74 may funnel pellets to the auger 78 and into the casing 82 via the opening 84 defined in the pellet hopper 74 to, thereby, move pellets 29 (FIG. 4A) along the auger toward the fire pot 18.

The auger housing 24 may be coupled to the pellet side portion 26 and may extend from the housing 72 of the pellet side portion to the smoking chamber 22 in the cooking body 16. Further, the auger housing 24 may extend with the heating element 80 positioned therein such that the heating element extends through the auger housing and partially into the fire pot 18. The fire pot 18 may define a fire pot opening 86 or be open along its upper side, the fire pot opening 86 configured to facilitate smoke to rise out of the fire pot 18. The auger housing 24 may also include a fan 88 positioned therein or positioned adjacent thereto. In some embodiments, the fan 88 may be positioned below the pellet hopper 74 and auger 78. The fan 88 may blow air into and through the auger housing 24 to blow air into the fire pot 18 to assist in igniting and fueling the burning pellets 29 (FIG. 4A) in the fire pot 18. The housing 72 may also include multiple vents 90 positioned at a bottom 92 of the housing 72. The multiple vents 90 may provide air flow to assist the fan 88 to circulate air flow through the housing 72 and the auger housing 24. Similar pellet feeder components of a smoker type cooking station are disclosed in commonly assigned U.S. Pat. No. 11,985,985, issued on May 21, 2024, the disclosure of which is incorporated herein in its entirety.

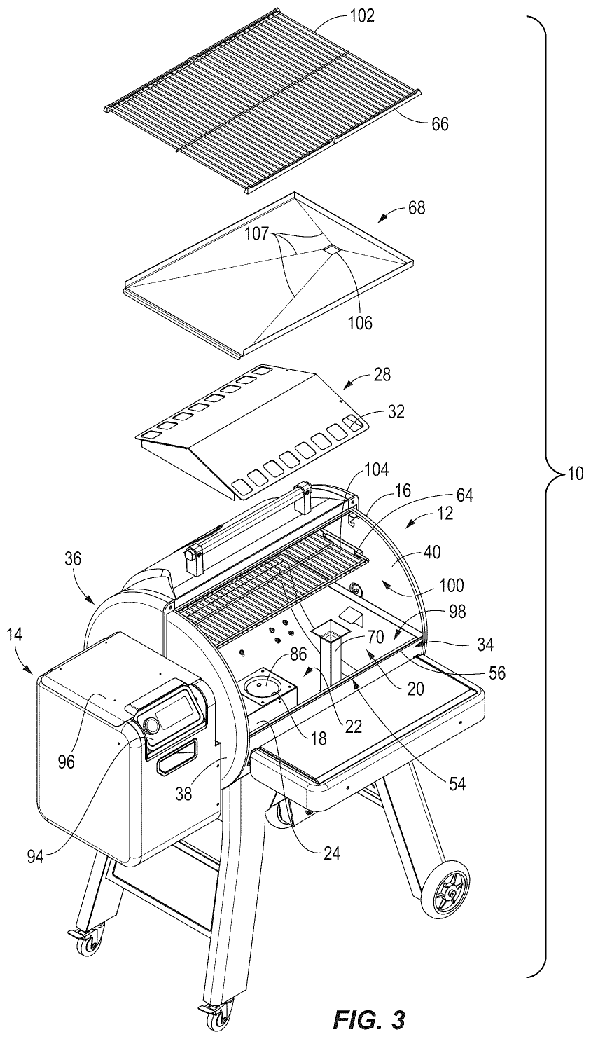

With reference to FIGS. 3-5, the pellet feeder system 14 may include a control panel 94 and a hopper lid 96 positioned along a top side of the pellet hopper 74. The hopper lid 96 may be configured to be opened to facilitate pouring pellets into the pellet hopper 74. The control panel 94 may be configured to control the pellet feeder system 14. For example, the control panel 94 may control the motor 76, the auger 78, the heating element 80, and the fan 88 such that the pellets 29 (FIG. 4A) may be fed to the fire pot 18 and be ignited by the heating element 80. Further, the control panel may control the pellet feeder system 14 for various time periods as well as to control a temperature of the cooking chamber 23 via various temperature sensors (not shown) within the cooking chamber 23 or smoking chamber 22, as known to one of ordinary skill in the art. In another embodiment, the control panel 94 may include pre-programmed controls with associated processors and sensors (not shown), as well as Wi-Fi controls, or the like, such that the cooking station 10 may be controlled remotely, as known to one of ordinary skill in the art.

Now, as previously stated, the smoking chamber 22 may include the lower grate 66 extending and positioned within the smoking chamber 22, from the rear side 36 to the front side 34 and from the left side 38 to the right side 40. Further, the smoking chamber 22 may define a lower chamber 98 and an upper chamber 100 (or a lower region and an upper region, respectively), the lower chamber 98 defined below the grease pan 68 and the portions of the cooking body 16 below the grease pan 68. The upper chamber 100 may be defined above the grease pan 68 and the surrounding walls of the cooking body 16 above the grease pan 68. The upper chamber 100 may also be referenced as the cooking chamber 23. The lower grate 66 may be positioned above the grease pan 68 and positioned in the upper chamber 100 of the smoking chamber 22. The lower chamber 98 may include the auger housing 24 of the pellet feeder system 14, the heat baffle 28, and an underside surface of the grease pan 68. As such, the heated smoke 31 (FIG. 4A) provided by the fire pot 18 may fill a portion of the lower chamber 98 of the smoking chamber 22 prior to filling the upper chamber 100. The upper chamber 100 may include the lower grate 66 and upper grate 64 both of which may define a lower cooking surface 102 and an upper cooking surface 104, respectively.

As previously set forth, the grease pan 68 (or otherwise referenced as a drip pan) may be positioned below the upper and lower grates 64, 66 to catch grease drippings and food debris of food cooked on the upper and lower grates 64, 66. The grease pan 68 may extend below or underneath the lower grate 66, which may partially be disposed within the lower chamber 98 of the smoking chamber 22. Further, the grease pan 68 may extend at an angle or be sloped towards a grease opening 106 defined therein. In another embodiment, the grease pan 68 may include grease channels 107 extending with the slope toward the grease opening 106. The grease pan 68 may be positioned within the lower chamber 98 so that the grease opening 106 may be positioned directly above the conduit 70. The grease conduit 70 may extend in upright or may extend longitudinally in a vertical manner from a floor 110 of the smoking chamber 22 to the grease opening 106 defined in the grease pan 68. In this manner, the grease drippings and food debris may be guided down the sloped surface of the grease pan 68 to the grease conduit 70 and towards a grease cup 112 positioned below the grease conduit 70. The grease cup 112 may be positioned externally or outside of the smoking chamber 22 below the cooking body 16. Further, the grease cup 112 may be positioned between the legs 42 of the main body 12 and below the cooking body 16. The grease cup 112 may capture grease drippings and food debris traveling through the grease conduit 70. Further, the grease cup 112 may be removable from the cooking body 16.

With reference to FIGS. 4-6, the heat baffle 28 may be positioned within the lower chamber 98 over the auger housing 24 of the pellet feeder system 14. Further, the heat baffle 28 may be positioned above the fire pot 18 at the end of the auger housing 24 and below the grease pan 68. In one embodiment, the heat baffle 28 may be positioned to define a first gap 114 between a left side of the heat baffle 28 and the left side 38 of the cooking body 16. As such, the heat baffle 28 may extend from the first gap 114 to the grease conduit 70. Further, the heat baffle 28 may be positioned to define a second gap 116 between a right side of the heat baffle 28 and the right side 40 of the cooking body 16. In this manner, the heat baffle 28 may be positioned above a portion of the auger housing 24 and the fire pot 18.

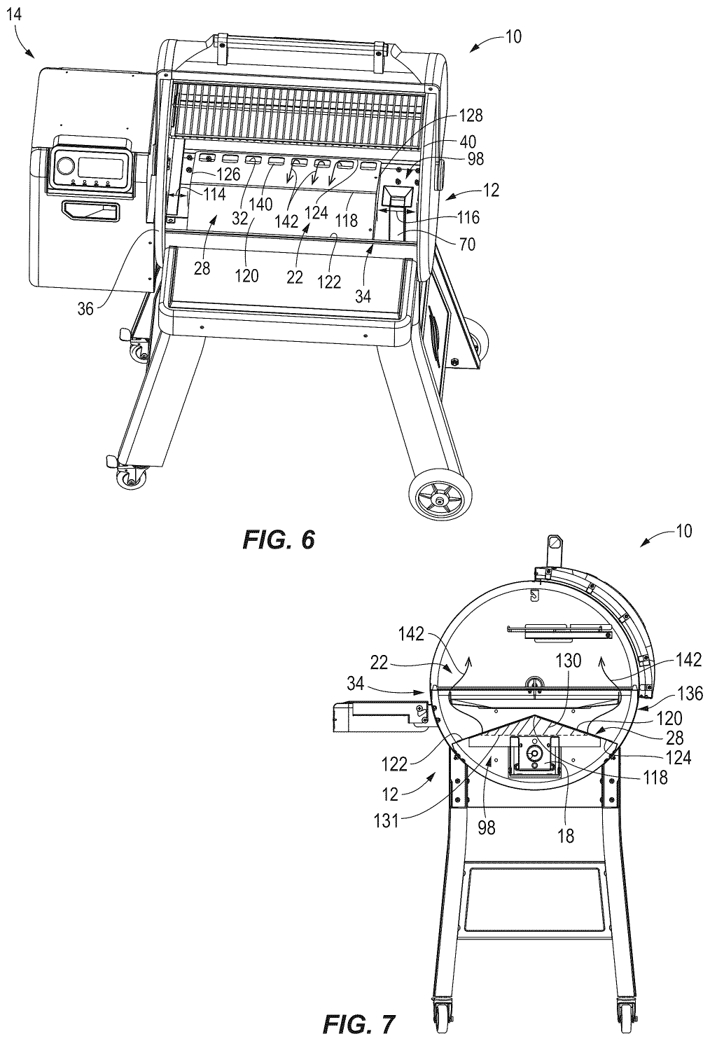

Now with reference to FIGS. 6-8, the heat baffle 28 may extend in a tent-like structure 118. Further, the heat baffle 28 may include an upper panel 120 extending with a front upper side 121 and a rear upper side 123 to define a peak 125 therebetween. The peak 125 between the front and rear upper sides 121, 123 may be formed as a bend in the upper panel 120, for example. Further, the upper panel 120 may extend to define a front periphery 122, a rear periphery 124, a left periphery 126, and a right periphery 128. The first and second upper sides 121, 123 of the upper panel 120 may extend with an upward slope from the front periphery 122 and the rear periphery 124 towards one another to the peak 125 to partially define the tent-like structure 118. Further, the heat baffle 28 may include a left wall 132 and a right wall 134 that may be fixed to an underside 136 of the upper panel 120, the left wall positioned adjacent the left periphery 126 and the right wall positioned adjacent the right periphery 128. Such left and right walls 132, 134 may extend directly away from the underside 136 of the upper panel 120 such that, upon the heat baffle 28 being in a use position within the cooking station 10, the left and right walls 132, 134 may extend generally vertically away from the underside 136 of the upper panel 120. In this manner, the upper panel 120 and the left and right walls 132, 134 may define the tent-like structure 118 of the heat baffle 28.

As previously set forth, the heat baffle 28 may be positioned within the lower chamber 98 of the smoking chamber 22 to define the first gap 114 and the second gap 116 along the sides of the heat baffle 28 and the respective left and right sides 38, 40 of the cooking body 16. The upper panel 120 of the heat baffle 28 may be positioned to extend between the first gap 114 and the second gap 116. Further, the left periphery 126 of the upper panel 120 may be positioned to partially define the first gap 114 and the right periphery 128 of the upper panel 120 may be positioned to partially define the second gap 116. As such, the tent-like structure 118 may extend between the first gap 114 and the second gap 116. Further, the front periphery 122 of the upper panel 120 may be positioned adjacent the front side 34 of the cooking body 16 and the rear periphery 124 of the upper panel 120 may be positioned adjacent the rear side 36 of the cooking body 16. In this manner, the upper panel 120 of the heat baffle 28 may be positioned to extend between the first gap 114 and the second gap 116 and between the front side 34 to the rear side 36 of the cooking body 16. The heat baffle 28 may be sized and configured to hold and retain some of the heated smoke 31 (FIG. 4A) produced in the fire pot 18 such that the heated smoke, as shown by lines 130, may fill the underside 136 of the heat baffle 28 toward the level of the dashed line 131, as depicted in FIG. 7. The dashed line 131 may define a plane, the plane extending along or adjacent a top 140 or leading edge of the openings 32 along the front and rear periphery 122, 124 of the heat baffle 28. Once the smoke reaches the level of the dashed line 131, the heated smoke may then move or may be dispersed adjacent a periphery of the heat baffle 28 (or along a top 140 of the openings 32 defined in the heat baffle 28) in a controlled and even manner, as depicted by arrows 142 (see FIGS. 6 and 7). As such, the tent-like structure 118 of the heat baffle 28 may be configured to fill-up with the heated smoke thereunder as shown by lines 130 in FIG. 7 (as well as being depicted by heated smoke 31 and arrow 33 in FIG. 4A).

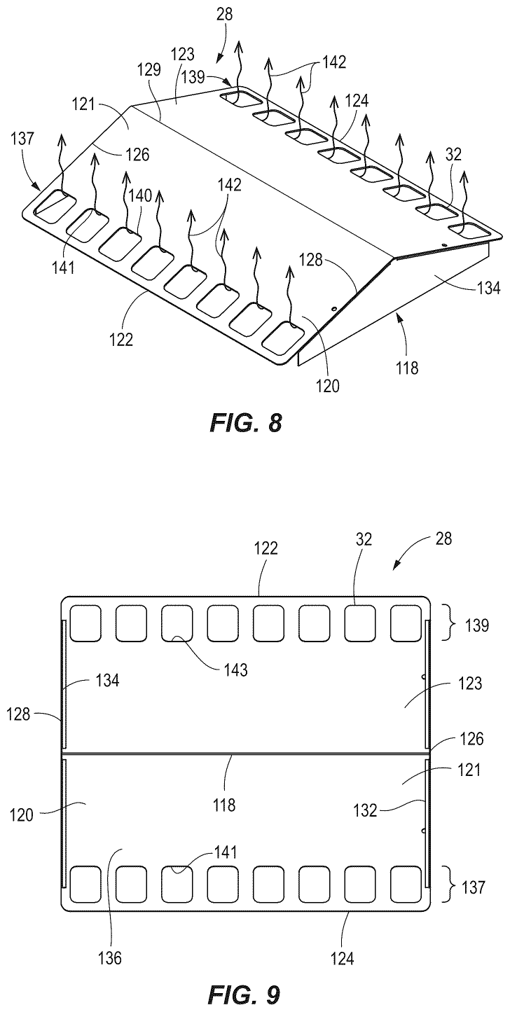

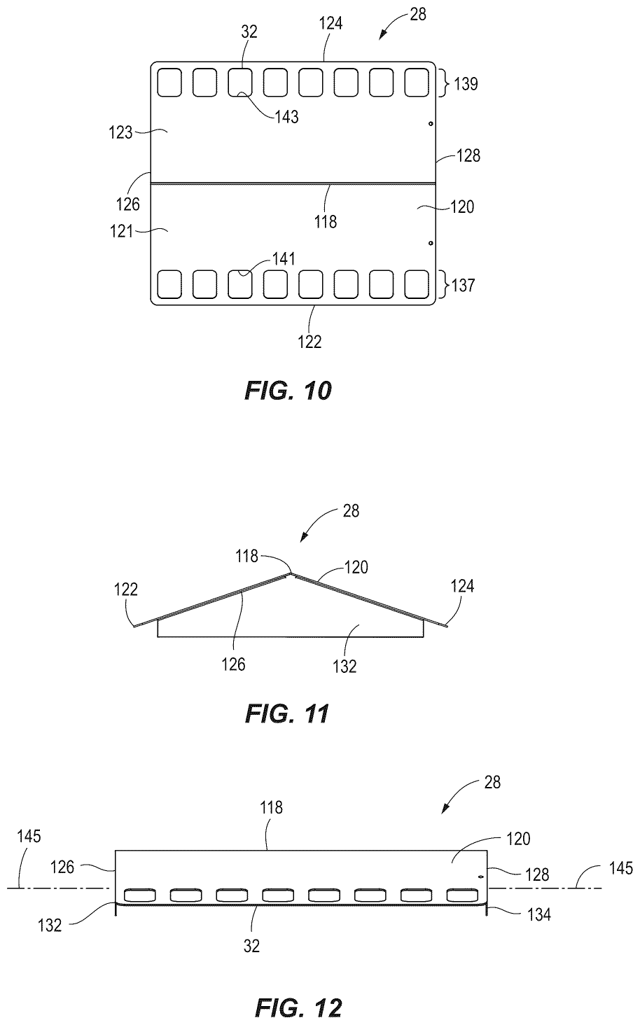

Now with reference to FIGS. 4, 4A and 8-12, as previously set forth, the upper panel 120 may include the front periphery 122, the rear periphery 124, the left periphery 126, and the right periphery 128. The left periphery 126 and the right periphery 128 may include the left wall 132 and the right wall 134 coupled adjacent thereto, respectively. The left wall 132 and the right wall 134 may extend somewhat perpendicular relative to the upper panel 120. The left periphery 126 and the right periphery 128 may extend past or beyond the respective left wall 132 and the right wall 134 of the heat baffle 28. In this manner, the left wall 132 and the right wall 134 may be somewhat inset relative to the upper panel 120 of the heat baffle 28. With this arrangement, the left wall 132 and the right wall 134 may be sized and configured to act as structure to further contain the heated smoke 31 within an upper portion 135 of the heat baffle 28 so that the upper portion 135 fills with the heated smoke along the underside 136 of the heat baffle 28, as depicted by arrow 33 in FIG. 4A.

Now, the upper panel 120 of the heat baffle 28 may extend to include the multiple openings 32 therein. The multiple openings 32 may be positioned, sized and configured to release the heated smoke 31 contained within the upper portion along the underside 136 of the heat baffle 28 in a consistent manner so that the heated smoke 31 generally moves from each of the openings 32 simultaneously with a similar amount of smoke being released from each of the openings 32 to move upward toward the cooking chamber 23. Further, the multiple openings 32 may be positioned on the front periphery 122 and the rear periphery 124 of the upper panel 120. The multiple openings 32 may include front periphery openings 137 so as to be evenly spaced apart and may be positioned in an aligned manner adjacent to the front periphery 122 of the heat baffle 28. Similarly, the multiple openings 32 may include rear periphery openings 139 that may be evenly spaced apart and may be positioned in an aligned manner adjacent to the rear periphery 124 of the heat baffle. Further, each of the front periphery openings 137 may be aligned so that a front side leading edge 141 of the front periphery openings 137 may be aligned with each other so as to be at a common level or height along the slope of the first upper side 121 of the upper panel 120 of the heat baffle 28. Similarly, each of the rear periphery openings 139 may be aligned so that a rear side leading edge 143 of the rear periphery openings 139 may be aligned with each other so as to be at a common level or height along the slope of the second upper side 123 of the upper panel 120 of the heat baffle 28. Also, in another embodiment, the front side leading edge 141 of the front periphery openings 137 may be at a common level or height along the underside 136 of the heat baffle 28 as the rear side leading edge 143 of the rear periphery openings 139. With this arrangement, as the heated smoke 31 fills the upper portion 135 along the underside 136 of the heat baffle 28, the heated smoke 31 may seep or escape from the underside 136 of the heat baffle 28 from the aligned multiple openings 32 along the front and rear side leading edges 141, 143 of the respective front and rear periphery openings 137, 139 in a consistent and simultaneous manner. That is, the heated smoke 31 may escape from each of the multiple openings 32 in a generally consistent amount per opening of the multiple openings 32 so as to begin being dispersed from each of the openings 32 in a simultaneous manner. Such heated smoke 31 being released or escaping through each of the openings 32 in a substantially simultaneous manner may be due to the rear and front side leading edges 141, 143 of the front and rear periphery openings 137, 139 being at a substantially similar level 145 or height along the slope of the heat baffle 28 and due to the heated smoke 31 filling the upper portion 135 along the underside 136 of the heat baffle 28 before escaping from the openings 32. Further, the heated smoke 31 being released or escaping through each of the openings 32 in a substantially consistent amount for each of the openings 32 may be due to the openings 32 being a similar or a consistent size, and as well as due to the front and rear side leading edges 141, 143 of the front and rear periphery openings 137, 139 being at a substantially similar level or height along the slope of the heat baffle 28 and due to the heated smoke 31 filling the upper portion 135 along the underside 136 of the heat baffle 28 before escaping from the openings 32. In one embodiment, the openings 32 may be rectangular or square each positioned and aligned along either the front or rear lead lines of the respective front and rear periphery openings. In another embodiment, the openings 32 may be circular or oval or even triangular such that a side edge, a radial edge, multi-edge or point of each of the openings 32 may be aligned at a common level or height (similar to the previously described front and rear leading edges) so as to facilitate the heated smoke 31 to escape the underside of the heat baffle 28 in a substantially consistent and simultaneous manner. As such, in any one of the embodiments set forth herein, the heated smoke 31 may escape from the underside 136 of the heat baffle 28 via the openings 32 defined therein so that the heated smoke 31 escapes adjacent to and along a majority of the elongated length of both the front and rear periphery 122, 124 of the heat baffle 28. In this manner, the multiple openings 32 may be positioned, sized and configured to release and disperse heat substantially evenly and substantially consistently from the underside 136 of the heat baffle 28 along front and rear lengths of the lower chamber 98 to rise into the upper chamber 100 or cooking chamber 23. In another embodiment, a heat baffle may include tent structure and openings (for heated smoke to move therethrough) to facilitate heated smoke 31 to rise substantially consistently and evenly along a left and right lengths of the lower chamber 98 to rise into the upper chamber 100 or cooking chamber 23. In another embodiment, a heat baffle may include tent structure and openings to facilitate heated smoke to move through the openings to rise substantially consistently and substantially evenly along front and rear lengths, as well as left and right lengths, of the lower chamber 98 to rise into the upper chamber 100 or cooking chamber 23.

Now with reference to FIGS. 4, 4A and 6-8, as previously stated the heat baffle 28 may be sized and configured to retain and release heated smoke 31 from thereunder. The heat baffle 28 may extend with the tent-like structure 118 which may allow for heated smoke 31 to be contained thereunder. The tent-like structure 118 in conjunction with the left wall 132 and right wall 134 may be configured to allow for the heated smoke 31 to build up as shown by lines 130 (FIG. 7). Further, the heat baffle 28 may be positioned and oriented above the fire pot 18 so that the openings 32 facilitate heated smoke to be released in a substantially consistent manner as described previously.

The multiple openings 32 may be positioned along the length of the front periphery 122 and rear periphery 124 so that the openings therealong with the respective front and rear side leading edges 141, 143 may be aligned. The tent-like structure 118 may allow for the heated smoke 31 to build up at a level that is in-line with a top 140 of each of the multiple openings 32 (or the front and rear side leading edges 141, 143, previously set forth). Once the heated smoke 31 fills the tent-like structure 118 to the level of the top 140 of the multiple openings 32, the heated smoke 31 may be funneled out along the top 140 of the multiple openings 32 as shown by arrows 142. As previously stated, the multiple openings 32 may be positioned in-line with one another. In this manner, the heated smoke 31 may be released from the underside 136 of the heat baffle 28 through the multiple openings 32 in a substantial even manner. As the heated smoke 31 is funneled from the underside 136 of the heat baffle 28, the heated smoke 31 may begin to disperse evenly throughout the remaining portion of the smoking chamber 22.

As previously stated, the grease pan 68 may be positioned directly above the heat baffle 28 and directly below the lower grate 66. The heated smoke may exit from the underside 136 of the heat baffle 28 and extend upwards past the grease pan 68 as shown by arrows 144. The heated smoke may then move in the upper chamber 100 through the lower grate 66 as shown by arrow 142 in FIG. 4. With this arrangement, the structure of the heat baffle facilitates evenly dispersing the heated smoke through the cooking chamber 23 to, thereby, facilitate heating and smoking food within the cooking chamber 23 in a more consistent manner despite where one may place the food along the upper and lower grates 64, 66 within the cooking chamber 23.

The various structural components of the various embodiments of the cooking station 10 with the heat baffle 28 and any other structural components thereof may be formed of various metallic materials, such as steel, stainless steel, copper, aluminum or any other suitable material with high temperature ratings, such as various suitable polymeric materials, and may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A smoker cooking station configured to be fueled with pellets and configured to disperse heat and smoke in a substantially even manner, the smoker cooking station comprising:
a main body extending to define a pellet feeder system and a smoking chamber, the pellet feeder system extending to a fire pot positioned adjacent a lower floor of the main body, the pellet feeder system configured to feed the pellets to the fire pot to be ignited and to produce heated smoke therein; and
a heat baffle having a tent structure with multiple openings defined therein, the multiple openings each having a leading edge along one side of the multiple openings, the leading edge of each of the multiple openings being aligned with each other along a majority of a length of the tent structure, the heat baffle positioned above the fire pot so that the tent structure is fillable with heated smoke from the fire pot so that, upon an upper portion of the tent structure being filled with the heated smoke, the heated smoke escapes the tent structure along the leading edge of each of the multiple openings aligned along the length of the heat baffle so that the heated smoke rises from each of the multiple openings along the majority of the length of the heat baffle to assist in evenly dispersing the heated smoke throughout the smoking chamber of the main body.

2. The smoker cooking station of claim 1, wherein the main body includes a drip pan and at least one cooking grate, the drip pan positioned above the heat baffle, and the at least one cooking grate positioned above the drip pan.

3. The smoker cooking station of claim 2, wherein the heat baffle is positioned below the drip pan such that heated smoke rises around a periphery of the drip pan.

4. The smoker cooking station of claim 2, wherein the drip pan is separate from the heat baffle such that, the drip pan is removable from the main body independent of the heat baffle.

5. The smoker cooking station of claim 1, wherein the tent structure of the heat baffle extends with a peak portion, the peak portion extending between a left wall and a right wall of the tent structure, the tent structure including a front sloped panel and a rear sloped panel each extending from the peak portion to a front periphery and a rear periphery, respectively, of the tent structure.

6. The smoker cooking station of claim 1, wherein the multiple openings are evenly spaced apart and aligned with each other.

7. The smoker cooking station of claim 1, wherein the multiple openings are positioned along a periphery of the tent structure.

8. The smoker cooking station of claim 1, wherein the tent structure extends with a sloped structure to hold heated smoke above the multiple openings defined in the heat baffle.

9. A smoker cooking station configured to be fueled by pellets and to disperse smoked heat therein in a substantially even manner, the smoker cooking station comprising:
a main body extending to define a pellet feeder system and a smoking chamber, the pellet feeder system extending to a fire pot positioned adjacent a lower floor of the main body, the pellet feeder system configured to feed the pellets to the fire pot to be ignited and to produce the heated smoke therein; and
a heat baffle extending to a periphery with multiple openings defined in the heat baffle, the multiple openings spaced apart and each defining a leading side edge such that the leading side edge of each of the multiple openings are aligned with each other, the heat baffle extending to define an underside surface configured to be above the multiple openings and configured to hold heated smoke therein, the heat baffle configured to be positioned over the fire pot so that, upon heated smoke filling up a space along the underside of the heat baffle, the heated smoke escapes the underside of the heat baffle along the leading side edge of each of the multiple openings so that the heated smoke rises from each of the multiple openings to assist in evenly dispersing the heated smoke throughout the smoking chamber of the main body.

10. The smoker cooking station of claim 9, wherein the main body includes a drip pan and at least one cooking grate, the drip pan positioned above the heat baffle, and the at least one cooking grate positioned above the drip pan.

11. The smoker cooking station of claim 10, wherein the heat baffle is positioned below the drip pan such that heated smoke rises around a periphery of the drip pan.

12. The smoker cooking station of claim 10, wherein the drip pan is separate from the heat baffle such that, the drip pan is removable from the main body independent of the heat baffle.

13. The smoker cooking station of claim 9, wherein the multiple openings are evenly spaced apart and aligned with each other.

14. The smoker cooking station of claim 9, wherein the multiple openings are positioned along a periphery of a dome structure.

15. The smoker cooking station of claim 9, wherein the dome structure extends with a sloped structure to hold heated smoke thereunder and above the multiple openings defined in the heat baffle.

16. A method for evenly dispersing heated smoke within a smoker cooking station, the method comprising:
providing a main body and a pellet feeder system of the smoker cooking station, the pellet feeder system extending to a fire pot positioned adjacent a lower floor of the main body, the pellet feeder system configured to feed the pellets to the fire pot to be ignited and to produce heated smoke therein, the main body including a heat baffle having a tent structure with multiple openings defined therein, the multiple openings each having a leading edge along one side of the multiple openings, the leading edge of each of the multiple openings being aligned with each other along a majority of a length of the heat baffle, the heat baffle positioned above the fire pot within a smoking chamber of the main body;
generating the heated smoke in the fire pot with pellets in the fire pot being fed thereto by the pellet feeder system such that the heated smoke rises to fill an upper portion along an underside of the tent structure; and
dispersing the heated smoke evenly into the smoking chamber with the heated smoke moving from the underside of the heat baffle and out of the multiple openings along the leading edge of each of the multiple openings aligned along the length of the heat baffle so that the heated smoke rises from each of the multiple openings along the majority of the length of the heat baffle to assist in evenly dispersing the heated smoke throughout the smoking chamber of the main body.

17. The method according to claim 16, wherein the providing the main body comprises providing the main body including a drip pan and at least one cooking grate, the drip pan positioned above the heat baffle, and the at least one cooking grate positioned above the drip pan.

18. The method according to claim 17, wherein the dispersing comprises dispersing the heated smoke evenly from the heat baffle to flow and rise around a periphery of the drip pan.

19. The method according to claim 16, wherein the dispersing the heated smoke comprises dispersing heated smoke from the multiple openings that are evenly spaced apart and aligned with each other.

20. The method according to claim 16, wherein the dispersing the heated smoke comprises orienting the heat baffle within the main body so that the multiple openings defined in the heat baffle disperses the heated smoke from each of the multiple openings in a substantially even manner within the smoking chamber.
